(19) United States
(12) Patent Application Publication
(10) Pub. No.: US 2014/0141806 A1
(43) Pub. Date: May 22, 2014

(54) Subscription-Free Open Channel Communications Optimized for Public Service Announcements

(71) Applicants: Ravindra Phulari, San Jose, CA (US); Mehul Sanghavi, Sunnyvale, CA (US); Michael Greenzeiger, Sunnyvale, CA (US)

(72) Inventors: Ravindra Phulari, San Jose, CA (US); Mehul Sanghavi, Sunnyvale, CA (US); Michael Greenzeiger, Sunnyvale, CA (US)

(73) Assignee: APPLE INC., Cupertino, CA (US)

(21) Appl. No.: 13/539,883

(22) Filed: Jul. 2, 2012

(51) Int. Cl. H04W 24/00

(52) U.S. Cl. 455/456.3

(57) ABSTRACT

Emergency and other alerts may be disseminated to mobile devices based on the location of the devices. Registered authorities may generate alerts having associated geographical boundaries. The alerts may be compiled at a central alert repository for distribution to devices within the geographical boundaries. Information transmitted by and indicative of the location of a mobile device may be compared with the alerts to determine if the location information coincides with the geographical boundaries of any of the alerts. If it is determined that one or more of the alerts are active for the device based on the device location, the one or more alerts may be transmitted to the device over an open communication channel dedicated to the communication of such alerts without prior subscription on the part of a user of the device.

### BACKGROUND

This disclosure relates generally to the targeted dissemination of alerts based on the location of a recipient device. More particularly, but not by way of limitation, this disclosure relates to techniques for receiving alerts from authorities and transmitting the alerts to devices within a geographic area defined by the alert.

Currently, the dissemination of public safety information and alerts typically occurs through various broadcast mediums. For example, the emergency alert system (EAS) may be utilized to disseminate weather alerts, child abduction (AMBER) alerts, presidential addresses, and alerts generated by other state and local authorities via terrestrial radio, over-the-air and cable television, satellite radio, satellite television, and roadside alert signs. While alerts disseminated in this manner may reach a large number of individuals, other potentially interested individuals that do not have access to one of the communication mediums at the time the alert is distributed may not receive the alert. Moreover, while the EAS may be appropriate for alerts targeted to a relatively broad audience (e.g., AMBER alerts, weather alerts, etc.), it may not be appropriate for emergency or other alerts targeted to a narrower audience. For example, it would be impractical to relay an alert relating to a fire at an apartment complex to thousands of people using the EAS.

It would be desirable to take advantage of the capabilities of mobile devices to target messages designated for either large or small audiences. For example, mobile devices such as smart phones are frequently in the possession of a user of the device, are typically capable of receiving various types of data, and are often location-aware. Current mobile device notification services enable users to subscribe to promotional or other content based on the location of their devices. In the context of public safety and other alerts, however, it is important that alerts be directed to and received by a device on a subscription-free basis.

### SUMMARY

In one embodiment, a method for delivering targeted alerts includes receiving alert information and corresponding geographic and duration information generated by an alert authority. Location information received from a mobile device may then be compared to the geographic and duration information to determine applicability of the alert information to the mobile device. At least some of the alert information may then be transmitted for delivery to the mobile device via an open communication channel of the mobile device. The method may be embodied in program code and stored on a non-transitory storage medium. The stored program code may be executed by a processor that is part of, or controls, a device used to distribute the alerts.

In another embodiment, a device includes program code to cause the device's processor to transmit current device location information, receive an alert from an alert repository that has associated geographical boundaries that coincide with the location information, and to present content of the alert to a user of the device. The alert may be received by the device via an open communication channel that is reserved for the communication of alerts from the alert repository.

### BRIEF DESCRIPTION OF THE DRAWINGS

FIG. 1A is a block diagram illustrating the components of an alert system in accordance with one embodiment.

FIG. 1B is a block diagram illustrating the segregation of an alert communication channel from other device communication channels in accordance with one embodiment.

FIG. 2 is a flowchart that illustrates the process by which an alert may be generated by an authority and subsequently transmitted to devices within a geographical zone specified by the alert.

FIG. 3 illustrates the geographic boundaries associated with several alerts generated in accordance with one embodiment.

FIG. 4 is a table illustrating the transmission of alerts to a device travelling through the geographic boundaries of the alerts illustrated in FIG. 3.

FIG. 5 is a block diagram of an illustrative electronic device in accordance with one embodiment.

### DETAILED DESCRIPTION

This disclosure pertains to the distribution of alerts to devices that have not registered to receive such alerts. In general, techniques are disclosed for compiling alerts generated by authorities, receiving location information from a device, identifying active alerts based on the location of the device, and transmitting the active alerts to the device via an open communication channel of the device. As used herein, an open communication channel refers to a communication channel that is dedicated to the communication of information associated with the alert system (e.g., a communication channel prioritized over other device communication channels) and by which the device may receive alerts on a subscription-free basis. An open channel can receive various communication mediums. The lowest common denominator for both mobile and fixed devices is text messaging, Advanced devices can receive web content, audio, video, etc.

In the following description, for purposes of explanation, numerous specific details are set forth in order to provide a thorough understanding of the inventive concepts. As part of this description, some of this disclosure's drawings represent structures and devices in block diagram form in order to avoid obscuring the invention. In the interest of clarity, not all features of an actual implementation are described in this specification. Moreover, the language used in this disclosure has been principally selected for readability and instructional purposes, and may not have been selected to delineate or circumscribe the inventive subject matter, resort to the claims being necessary to determine such inventive subject matter. Reference in this disclosure to “one embodiment” or to “an embodiment” means that a particular feature, structure, or characteristic described in connection with the embodiment is included in at least one embodiment of the invention, and multiple references to “one embodiment” or “an embodiment” should not be understood as necessarily all referring to the same embodiment.

It will be appreciated that in the development of any actual implementation (as in any development project), numerous decisions must be made to achieve the developers' specific goals (e.g., compliance with system- and business-related constraints), and that these goals will vary from one implementation to another. It will also be appreciated that such development efforts might be complex and time-consuming, but would nevertheless be a routine undertaking for those of ordinary skill in the art of mobile device communications having the benefit of this disclosure,

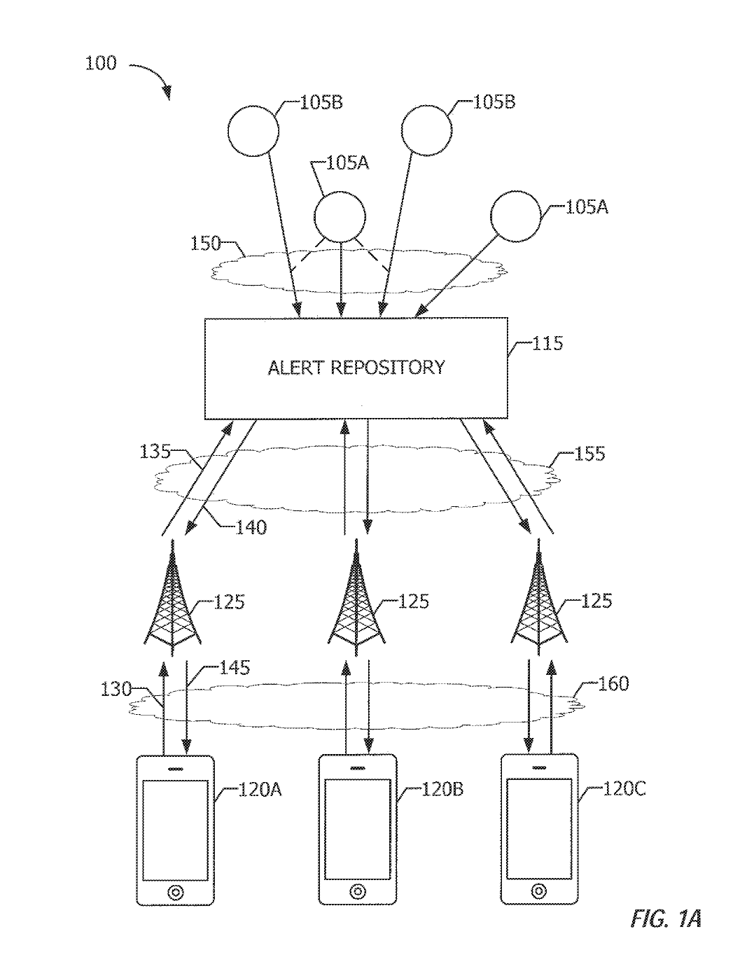

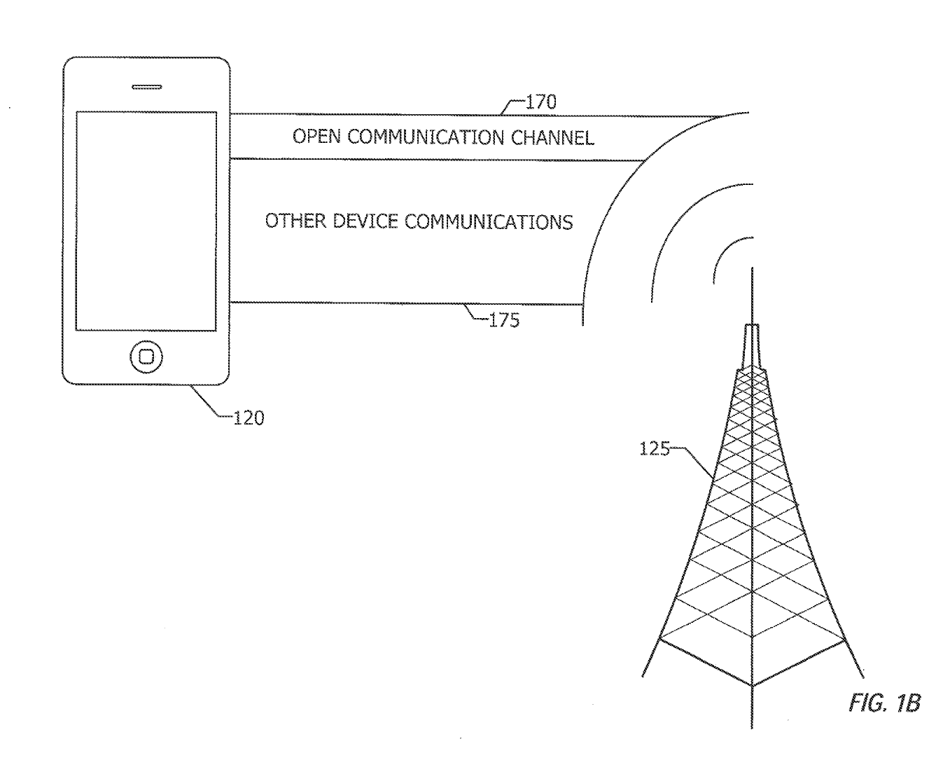

Referring to FIG. 1A, alert system 100 is illustrated in accordance with one embodiment. Alert system 100 includes multiple alert-generating authorities 105. As will be described in greater detail below, authorities 105 may generate alerts to be communicated to devices 120 via alert system 100. As is illustrated, there may be different levels of authorities 105 (e.g., 105A level authorities and 105B level authorities). In one embodiment, alerts generated by a 105B level authority may apply to a more localized area. A 105B level authority may be a building manager, a school administrator, an operator of an industrial plant, etc. These authorities may be able to generate localized alerts pertaining to their specific area of jurisdiction (e.g., building evacuation instructions or updates regarding a school incident). Therefore, in one embodiment, the geographic boundaries of an alert generated by a 105B level authority may be fixed such that any alert generated by such an authority is applicable within the predefined boundary (e.g., a geographic boundary limited to a school campus and surrounding areas).

In one embodiment, a 105A level authority may have broader jurisdiction for creating alerts. Examples of such authorities may include the National Weather Service (NWS), the Department of Homeland Security (DHS), the Federal Aviation Administration (FAA), etc. These 105A level authorities may be able to generate alerts that apply to broader geographic regions. In one embodiment, a 105A level authority may be able to define the geographic boundaries within which a generated alert will be active (i.e., the boundaries may not be predefined based on the authority as may be the case for a 105B level authority). In such an embodiment, a 105A level authority may only be able to define boundaries for an alert where those boundaries are contained within a predefined jurisdiction. For example, a state Department of Transportation authority may be able to define boundaries for an alert within the state but not extending beyond the state's borders.

As indicated in the illustrated embodiment, a 105A level authority may also approve alerts generated by a 105B level authority. For example, each 105B level authority may fall under the supervision of a 105A level authority. Alerts generated by a 105B level authority may only be published after they are approved by the supervising 105A level authority. An alert generated by a 105B level authority may be created in the same manner as an alert generated by a 105A level authority but may not be disseminated to devices 120 until approved by a supervisory authority. It will be understood that although two authority levels are illustrated, more or fewer levels may also exist.

According to one embodiment, alerts may be generated by authorities 105 using an alert publishing tool. The publishing tool may be a software application that interfaces with alert repository 115 via network 150. Alert repository 115 may be a server-side application that executes on one or more alert servers while the publishing tool may be a client-side application that executes on a client device utilized by an authority 105 to create an alert. Network 150 may take any form including, but not limited to, a local area network (LAN), a wide area network (WAN) such as the Internet or a combination of local and wide-area networks. Moreover, the network may use any desired technology (wired, wireless or a combination thereof) and protocol (e.g., transmission control protocol, TCP). Although network 150 is illustrated as a single network, it will be understood that authorities 105 may interface with alert repository 115 via separate networks.

Each authority may be granted credentials that allow them to access an account within alert repository 115. An authority account may define an authority level, the geographic region that applies to generated alerts (for lower level authorities), the geographic region within which the authority may generate alerts (for higher level authorities), a supervisory authority, etc. The publishing tool may allow authority 105 to establish the parameters of an alert. For example, using the publishing tool, an authority 105 may define the alert content (e.g., the text, audio, video, or other content that will be delivered with the alert), the geographic boundaries within which the alert applies (if not predefined based on the authority level), the duration of the alert (i.e., when the alert expires), etc. When an alert is created by an authority in such a manner, it may be maintained by alert repository 115 for dissemination to devices 120 according to the defined alert parameters (e.g., duration and location parameters).

Alert providers 125 may interface with alert repository 115 via network 155. Like network 150, network 155 may take any form and may in actuality represent multiple communication networks. As used herein, an alert provider refers to an entity that interfaces between devices 120 and alert repository 115. As will be described in greater detail below, alert system 100 may be based on an open communication standard. Therefore, according to one embodiment, alert provider 125 may be any entity capable of interfacing with devices 120 in accordance with the alert communication standard. For example, alert providers 125 may be wireless communication service providers, manufacturers of devices 120, third party providers, etc.

Alert providers 125 may communicate with devices 120 via network 160. Like networks 150 and 155, network 160 may take any form and may represent multiple communication networks. Although alert providers 125 are illustrated as radio-based communication providers, it is not necessary that network 160 be a wireless communication network. Rather, devices 120 may communicate with alert providers 125 via any network that enables communications via an open communication channel in accordance with the alert system protocol.

Device 120 may regularly transmit location information to alert provider 125 (130). In one embodiment, location identification may be based on global positioning satellite (GPS) location information known by device 120. In another embodiment, location identification may be based on triangulation methods. Location information may be provided anonymously. That is, while location information may be provided by device 120, no personally identifiable information will be transmitted. The transmission of location information may occur with or without the knowledge of a user of device 120. Moreover, transmission of location information may occur regardless of the device's state (i.e., whether or not the device is in active use). Device 120 may be a mobile device (such as a mobile phone, laptop computer, GPS device, a device integrated into an automobile, or any other type of mobile device capable of sending location information and receiving alerts via an open channel) or a fixed/wired device (such as a desktop computer, television, etc.).

In response to the receipt of location information from device 120, alert provider 125 may query alert repository 115 for active alerts based on the location information (135). Alert repository 115 may respond with active alerts based on device 120's location (140). The active alerts may then be sent by alert provider 125 to device 120 (145).

Referring to FIG. 1B, communications between device 120 and alert provider 125 in accordance with alert system 100 may occur via open communication channel 170. Open communication channel 170 may be prioritized over channels for other device communications 175. In a first embodiment, open communication channel 170 may be utilized to receive push notifications sent via alert system 100. In a second embodiment, device 120 may continuously “listen in” on open communication channel 170 (e.g., a broadcast radio wave) or may utilize open communication channel 170 to poll a service for active alerts. Thus, while regular communications activities (e.g., voice calls, SMS text messaging, and other data communications) for device 120 may occur via other communication channels 175, open communication channel 170 may be available for the communication of alerts at any time regardless of other ongoing communications. Therefore, open communication channel 170 represents a dedicated communication channel by which communications related to alert system 100 may occur.

Regardless of the specific manner in which open communication channel 170 is implemented, device 120 will be “opted-in” to receive active alerts without any prior subscription, It should be noted that open communication channel 170 may be used for both broadcast and personalized communications. For example, alerts that apply to a broader region may be received as a broadcast over open communication channel 170 whereas more localized alerts may be received as a personalized alert (e.g., pushed or pulled from the alert system) over open communication channel 170. If alert system 100 is based on a communication standard, device makers and data/wireless carriers may be required to reserve a particular frequency, device communications port, etc. as open communication channel 170 for the communication of alerts.

In one embodiment, open communication channel 170 may be utilized for the communication of any information related to alert system 100. For example, open communication channel 170 may be utilized to transmit device location information (130) as well as to receive alerts (145). Alerts may be delivered to device 120 via various methods. For example, alerts may be received as short messaging service (SMS) text messages, emails, instant messages, streaming audio or video, etc. Moreover, as will be described below, the type of content that is delivered to device 120 may depend on the capability of device 120.

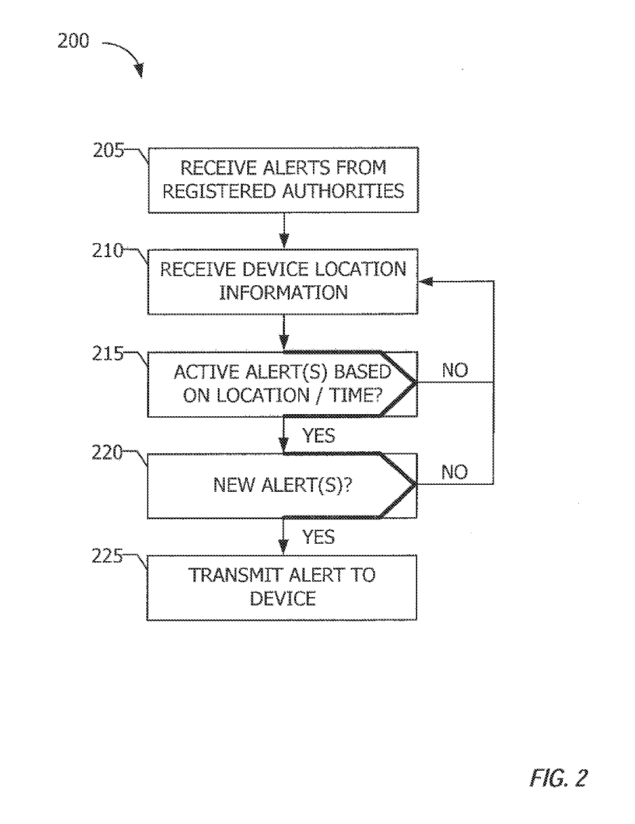

Referring to FIG. 2, alert transmission process 200 may begin with the receipt of alerts from registered authorities (block 205). As described briefly above, authorities may register to obtain access to an alert distribution system. Each authority may be granted permission to generate alerts applicable to a predefined geographic region or within a predefined geographic region. By requiring registration, the legitimacy of an authority may be verified such that only legitimate authorities are granted access to generate alerts via alert system 100. Upon approval, each authority may be able to generate an alert by accessing an account with the alert distribution system using authority credentials. As described above, an authority may utilize a client-side application that interfaces with a corresponding server-side application to generate an alert.

In one embodiment, an alert may include content and metadata. The content of a message may include the text, audio, video, or other data that will be presented to a user of a device on which the alert is received. The content of an alert may be defined by an authority through an alert publishing tool (e.g., application software utilized to interface with the alert system). For example, an audio file may be created by an authority and attached as the content of an alert generated by the authority. In such an embodiment, the audio the may be presented (e.g., downloaded and played by or streamed to) on a device receiving the alert. In another embodiment, the content of an alert may include instructions to obtain additional information (e.g., a hyperlink to additional information). In yet another embodiment, an alert may include content of various forms that may be delivered based on the capabilities or properties of the device. For example, textual data associated with an alert may be delivered to a device having limited capability whereas the same alert may cause a device with greater capability to display a video clip or still image. Thus, in addition to device location information, a device may additionally send capability information such that the appropriate alert content may be selected for the device. In still another embodiment, alert content may include instructions to obtain information via another communication channel. For example, an alert may include instructions to automatically set a device tuner to a certain frequency on which information may be broadcast over the air. This may be particularly useful when the alert includes audio or video data to be delivered in real-time over a broad geographical region (e.g., the audio of a live presidential address). Rather than streaming the alert content to numerous devices individually, the devices may be instructed to tune to a particular frequency on which the content may be broadcast.

The metadata related to an alert may also be defined by an authority through an alert publishing tool. The alert metadata may include the geographic region in which the alert is applicable (i.e., the zone in which devices will receive the alert), the duration of the alert (i.e., when the alert will expire), and a priority level of the alert. The priority level may define how the device handles the alert. Although alerts may be delivered to applicable devices over an open communication channel that takes precedence over other device communications channels, the manner in which the alert is presented to the user upon receipt may be based upon the priority level. For example, an alert having a higher priority may cause the device to disconnect an ongoing telephone call and immediately play audio content associated with the alert whereas an alert having a lower priority may play the audio content upon termination of the phone call. The priority level may also define user level override privileges. For example, alert content associated with a certain alert priority level may not be dismissible for a certain period of time (e.g., the alert content may be displayed continuously on a recipient device for 10 seconds). Alert metadata may also specify a linkage of an alert to a previous alert. If an alert is linked to an earlier alert, a device that received the earlier alert may also receive the linked alert even if the linked alert is not applicable based on the current location of the device. For example, a user of a device that evacuates an area based on a storm warning alert may receive a linked alert that provides instructions for returning to the area even though their evacuation location may not be within the geographic boundaries specified in the linked alert.

In conjunction with the receipt of alerts from registered authorities, device location information may also be received (block 210). As set forth above, devices 120 may periodically transmit current location information to alert provider 125 which may re-transmit the location information (e.g., as a query for alerts that are active for the received location information) to alert repository 115. Alert repository 115 may be a server-side alert application that compares device location information received from multiple alert providers 125 for numerous devices 120 with alerts generated by numerous registered authorities. More specifically, alert repository 115 may identify alerts that are in effect (i.e., alerts that are within a specified duration time) and compare alert location metadata for the identified alerts to the received device location information. As such, it may be determined if any alerts generated by the registered authorities are active based on the location of a device and the pendency time of an alert (block 215). If it is determined that one or more alerts are active based on device location information and alert location metadata (the “Yes” prong of block 215), it may then be determined if the one or more active alerts are new to the particular device (block 220). That is, it may be determined if the alert has been previously transmitted to the device. For example, if a device enters a geographic region in which an alert is active, the alert may be transmitted to the device. When the device thereafter transmits new location information indicating that the device is still located in the region of the alert, it should be determined that the device has already received the alert and that the alert should not be transmitted to the device again. It should be noted, however, that an alert may be created such that the content of the alert is intentionally provided to a single device multiple times. For example, an alert that instructs residents of a particular area to evacuate the area may include metadata to repeat the alert periodically for as long as the device remains in the area.

If it is determined that there are no active alerts based on time and device information or that any active alerts have already been sent to the device (the “No” prongs of blocks 215 and 220 respectively), alert repository 115 may continue to monitor device location information to determine whether updated location information coincides with the geographical boundaries of an alert that is in effect (block 210). If, however, it is determined that one or more active alerts have not been previously transmitted to the device (the “Yes” prong of block 220), the active alerts may be sent to the device (e.g., pushed to the device or retrieved by the device). As described above, alert system 100 may be based on an open communication standard according to which alerts may be communicated to devices via an open communication channel that takes precedence over other device communication channels and by which the alerts are delivered without prior subscription to any service by the user. Therefore, in accordance with alert transmission process 200, alerts generated by registered authorities may be delivered to devices 120 without any subscription on the part of the device. Although the actions of process 200 have generally been described as being performed by alert repository 115, it will be understood that some or all of the described actions may be performed by alert providers 125. For example, alerts received at alert repository 115 may be sent to alert providers 125 and the management of active alerts for the devices that a particular alert provider 125 services may be performed by alert provider 125. In another embodiment, an alert provider may manage or control a portion of alert repository 115.

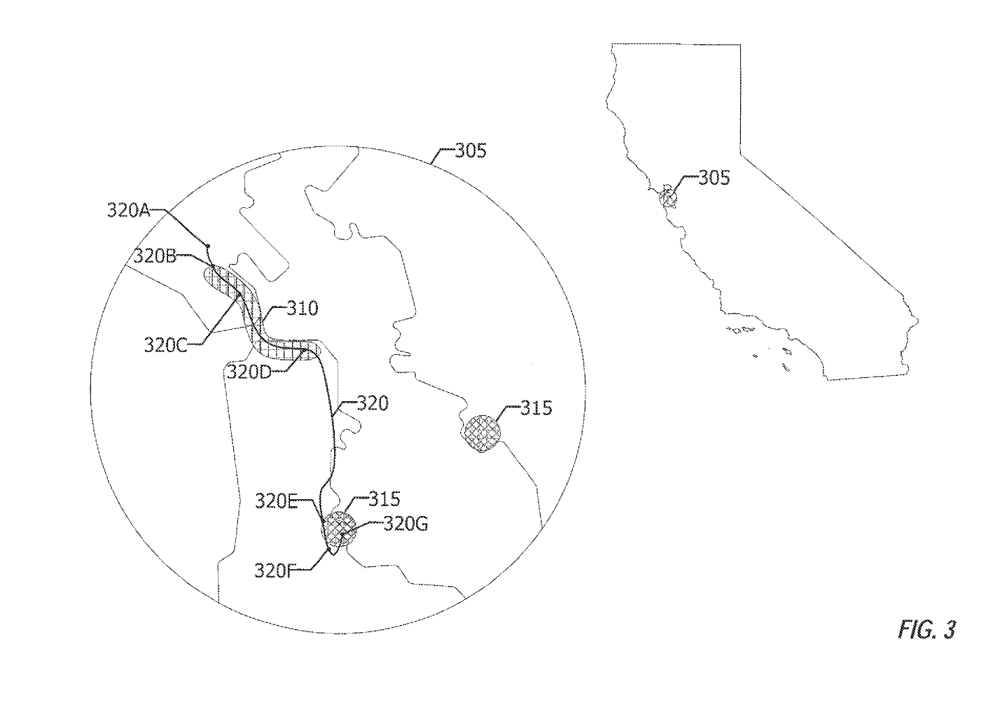

Referring to FIG. 3, alert system 100 is described in terms of various alerts having different geographic boundaries. In the illustrated example, alert 305 is issued for a geographical region in the San Francisco Bay Area in northern California. By way of example, alert 305 may be generated to caution people in the area of an approaching storm or road closures and the like associated with an earthquake. Alert 305 may be generated by a weather authority 105 for publication via alert system 100. Devices within the boundaries set forth in alert 305 metadata during the time alert 305 is in effect may receive the content of the alert (e.g., a text, audio, or video message) on their device according, for example, to process 200.

Within the boundaries set forth for alert 305, additional localized alerts may also be active. Alert 310 may provide information regarding a car accident or construction work on or near the golden gate bridge. Such an alert may be generated by a state or county transportation authority 105 and may include geographical boundaries defined by the authority within predefined jurisdictional boundaries for the authority. In the illustrated example, the geographical boundaries defined by alert 310 metadata extend along a section of highway such that the content of alert 310 may only be presented to those individuals that are approaching the area affected by the alert. As such, alerts delivered in accordance with alert system 100 may be targeted such that they are only received by individuals that are most likely to be affected by the information described in the alert. As illustrated, an authority 105 may define alert boundaries having a unique shape that is appropriate for the type of alert.

Also active within the boundaries defined by alert 305 is alert 315. Alert 315 may provide information pertaining to travel through any United States airport of a particular size. Such an alert may be generated by a federal agency authority 105 such as the Department of Homeland Security or the Federal Aviation Administration. In the illustrated example, alert 315 is active within geographic boundaries surrounding the San Francisco International Airport as well as the Oakland International Airport. As illustrated, an alert may not necessarily be defined by a single contiguous region but may instead include multiple isolated regions.

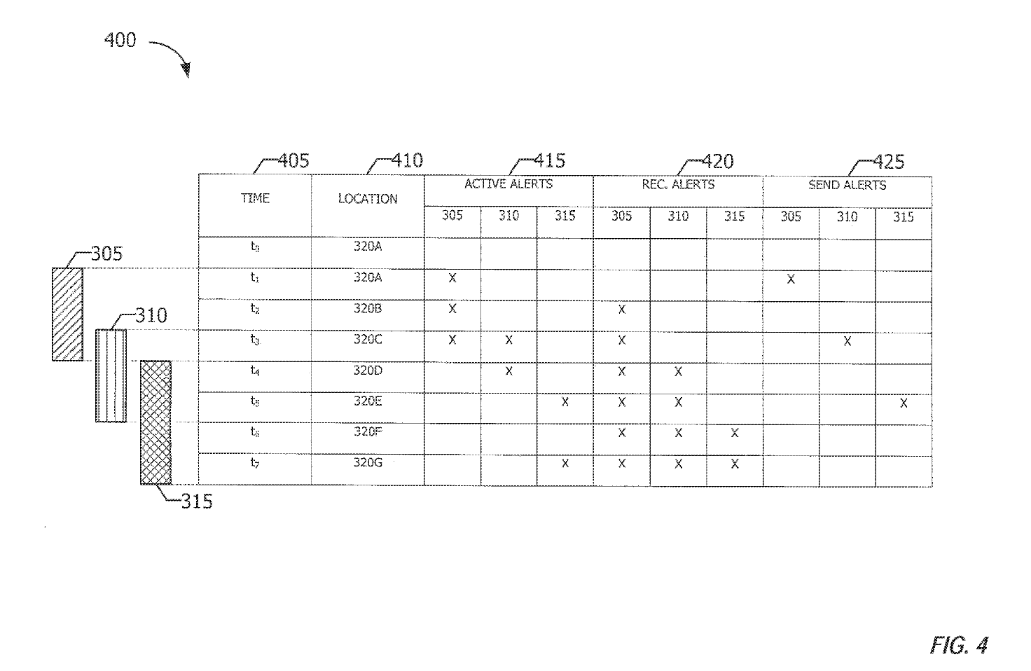

FIG. 3 additionally illustrates path 320 travelled by device 120 from initial location 320A to final location 320G. Referring to FIG. 4 in conjunction with path 320 illustrated in FIG. 3, table 400 illustrates the management of alerts for device 120 in accordance with an embodiment of alert system 100. Column 405 of table 400 illustrates time values, column 410 illustrates the location of device 120 along path 320 at each of the specified times, column 415 illustrates active alerts based on the location of device 120 as compared to the boundaries for alerts that are in effect, column 420 maintains a record of the alerts that device 120 has already received, and column 425 illustrates the transmission of new alerts to device 120. In conjunction with table 400, an indication of the duration of each of alerts 305, 310, and 315 is provided. As illustrated, alert 305 is active from time t₁ through time t₃, alert 310 is active from time t₃ through time t₅, and alert 315 is active from time t₄ through time t₇.

At time t₀, device 120 is at location 320A, but no alerts are in effect. Therefore, no alerts are sent to device 120. At time t₁, device 120 is still situated at location 320A and alert 305 is in effect. Because device 120 is located within the boundaries defined for alert 305, when device 120 transmits its location information, it may be determined that alert 305 is an active alert (415). It may then be determined that alert 305 has not been previously sent to device 120 (420) and that alert 305 should therefore be sent to device 120 at time t₁ (425). To reiterate, alert 305 may be transmitted to device 120 via an open communication channel by which device 120 is always accessible (i.e., always accessible in a powered-on state).

At time t₂, alert 305 is still in effect and device 120 has moved to location 320B. It may be determined from device 120's location information that alert 305 is still an active alert for device 120 (415), that alert 305 has already been sent to device 120 (420), and that no additional alerts need to be transmitted to device 120 (425). At time t₃, both alert 305 and alert 310 are in effect and device 120 has moved to location 320C. It may be determined from device 120's location information that alerts 305 and 310 are active alerts (415), that alert 305 has already been sent to device 120 (420), and that alert 310 should be transmitted to device 120 (425). At time t₄, alerts 310 and 315 are in effect, alert 305 has expired, and device 120 is at location 320D. Based on this information, it r may be determined that alert 310 is the only active alert for device 120 (415), that alert 310 has already been sent to device 120 (420), and that no alerts should be sent at time t₄ (425). Although table 400 illustrates data pertaining to the prior transmission of alert 305 to device 120 at times t₄ through t₇, in an alternate embodiment, such information may be deleted when the alert expires. At time t₅, alerts 310 and 315 are in effect and device 120 is at location 320E. Based on this information, it may be determined that alert 315 is an active alert for device 120 (415). Moreover, because alert 315 has not been previously transmitted to device 120 (420), it may be sent at time t₅ (425). At time t₆, alert 315 is in effect but device 120 has travelled outside of the boundaries for alert 315 to location 320F. Thus, alert 315 is not an active alert at time t₆ (415). At time t₇, alert 315 is still in effect and device 120 has re-entered the boundaries for alert 315 at location 320G. Therefore, alert 315 is again an active alert for device 120 at time t₇ (415). However, because alert 315 has been previously transmitted to device 120 (420), the alert is not re-transmitted based on device 120's re-entry into the alert 315 boundaries. In another embodiment, alert 315 metadata may indicate that the content of alert 315 should be re-transmitted based on re-entry. In such an embodiment, alert 315 may be re-transmitted to device 120 upon device 120's re-entry into the boundaries for alert 315. Information such as that indicated in table 400 may be maintained in a data store at either alert repository 115 or alert provider 125 for the management of alerts for numerous devices 120. As described above, the alert content delivered to a particular device may be dependent on the capabilities of the device. Accordingly, a data store at either alert repository 115 or alert provider 125 may additionally include device capability information such that the appropriate alert content may be delivered to a device.

Although the example alerts described in FIGS. 3 and 4 apply to relatively large geographical areas, it will be understood that alert system 100 is equally applicable to alerts that apply to more localized geographical areas. For example, a building manager authority may generate an alert instructing residents and visitors of the building (i.e., anyone within the vicinity of the building as defined by the boundaries of the alert) to evacuate the building due to a fire. Thus, in contrast to existing alert systems, alerts may be generated by registered authorities and may be targeted such that they are distributed only to those individuals that may be affected by the alert (e.g., only those individuals in a localized area).

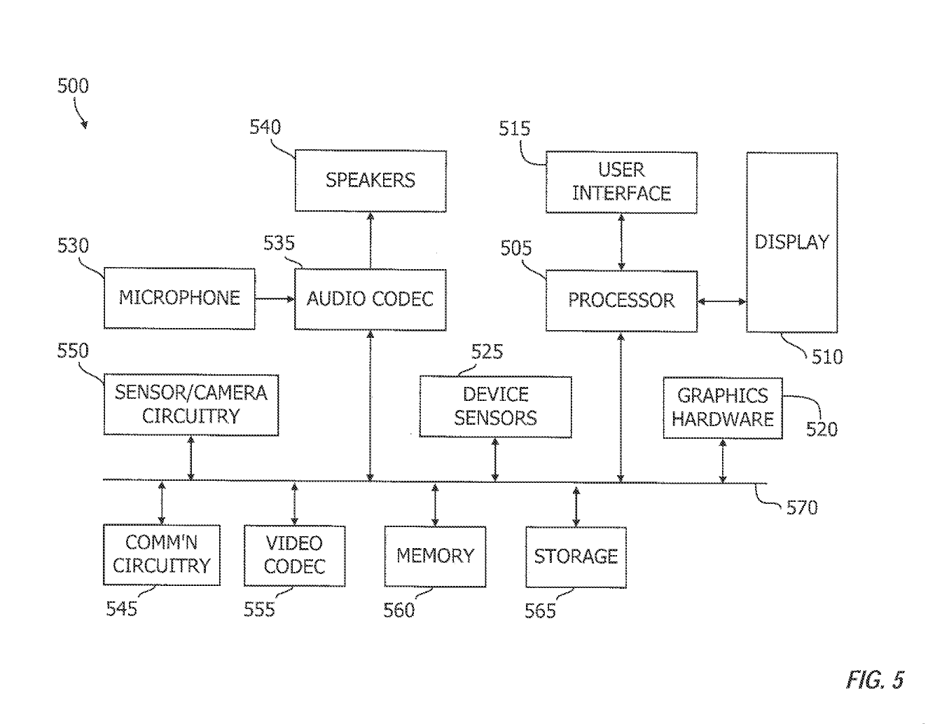

Referring to FIG. 5, a simplified functional block diagram of illustrative electronic device 500 is shown according to one embodiment. Electronic device 500 may include processor 505, display 510, user interface 515, graphics hardware 520, device sensors 525 (e.g., proximity sensor/ambient light sensor, accelerometer and/or gyroscope), microphone 530, audio codec(s) 535, speaker(s) 540, communications circuitry 545, digital image capture unit 550, video codec(s) 555, memory 560, storage 565, and communications bus 570. Electronic device 500 may be, for example, a personal digital assistant (PDA), personal music player, mobile telephone, notebook, laptop or a tablet computer, desktop computer, or server computer. More particularly, any of the devices described above (e.g., devices 120 or the client and server devices for generating alerts) may take the form of device 500.

Processor 505 may execute instructions necessary to carry out or control the operation of many functions performed by device 500. Processor 505 may, for instance, drive display 510 and receive user input from user interface 515. User interface 515 can take a variety of forms, such as a button, keypad, dial, a click wheel, keyboard, display screen and/or a touch screen. Processor 505 may also, for example, be a system-on-chip such as those found in mobile devices and include a dedicated graphics processing unit (GPU). Processor 505 may be based on reduced instruction-set computer (RISC) or complex instruction-set computer (CISC) architectures or any other suitable architecture and may include one or more processing cores. Graphics hardware 520 may be special purpose computational hardware for processing graphics and/or assisting processor 505 to process graphics information. In one embodiment, graphics hardware 520 may include a programmable graphics processing unit (GPU).

Sensor and camera circuitry 550 may capture still and video images that may be processed, at least in part, by video codec(s) 555 and/or processor 505 and/or graphics hardware 520, and/or a dedicated image processing unit incorporated within circuitry 550. Images so captured may be stored in memory 560 and/or storage 565. Memory 560 may include one or more different types of media used by processor 505 and graphics hardware 520 to perform device functions. For example, memory 560 may include memory cache, read-only memory (ROM), and/or random access memory (RAM). Storage 565 may store media (e.g., audio, image and video files), computer program instructions or software, preference information, device profile information, and any other suitable data. Storage 565 may include one or more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 560 and storage 565 may be used to tangibly retain computer program instructions or code organized into one or more modules and written in any desired computer programming language. When executed by, for example, processor 505 such computer program code may implement one or more of the methods described herein.

It is to be understood that the above description is intended to be illustrative, and not restrictive. The material has been presented to enable any person skilled in the art to make and use the inventive concepts described herein, and is provided in the context of particular embodiments, variations of which will be readily apparent to those skilled in the art (e.g., some of the disclosed embodiments may be used in combination with each other). Many other embodiments will be apparent to those of skill in the art upon reviewing the above description. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

1. A non-transitory program storage device, readable by a processor and comprising instructions stored thereon to cause the processor to:
receive alert information having corresponding geographic region information from an alert authority;
receive location information from a device;
determine that the alert information is applicable to the device based, at least in part, on the received location information and the corresponding geographic region information; and
transmit at least some of the alert information for delivery to the device via an open communication channel of the device.

2. The non-transitory program storage device of claim 1, wherein the alert information comprises alert content and alert metadata.

3. The non-transitory program storage device of claim 2, wherein the alert metadata comprises an alert duration.

4. The non-transitory program storage device of claim 2, wherein the alert metadata comprises an alert priority level.

5. The non-transitory program storage device of claim 2, wherein the alert content comprises textual data.

6. The non-transitory program storage device of claim 1, wherein the transmitted alert information comprises user level override information.

7. The non-transitory program storage device of claim 1, wherein the instructions to cause the processor to receive alert information comprise instructions to cause the processor to receive alert information having a content portion that is dependent upon device capability.

8. The non-transitory program storage device of claim 7, further comprising instructions to receive device capability information from the device.

9. The non-transitory program storage device of claim 8, wherein the instructions to cause the processor to transmit at least some of the alert information for delivery to the device via an open communication channel comprise instructions to cause the processor to select a type of alert content from the alert information based, at least in part, on the received capability information.

10. The non-transitory program storage device of claim 1, further comprising instructions to cause the processor to determine whether any of the alert information has been previously transmitted to the device.

11. The non-transitory program storage device of claim 10, wherein the instructions to cause the processor to transmit at least some of the alert information for delivery to the device via an open communication channel comprise instructions to cause the processor to transmit only alert information that has not been previously transmitted to the device.

12. An alert publishing method, comprising:
receiving alert information generated by a registered authority through an alert publishing system, the alert information having associated geographical boundaries and an associated duration time;
receiving device location information from a device;
determining the device location information corresponds to a location within the geographical boundaries;
determining the alert information is in effect based on the duration time; and
sending at least some of the alert information to the device via an open communication channel of the device.

13. The method of claim 12, wherein the alert information comprises instructions to cause the device to retrieve information via another communication channel.

14. The method of claim 13, wherein the instructions to cause the device to retrieve information via another communication channel comprise instructions to cause the device to set a device tuner to receive a broadcast associated with the alert information.

15. The method of claim 12, wherein the geographical boundaries comprise two or more isolated geographical regions.

16. A device, comprising:
a memory;
a display element; and
a processor operatively coupled to the memory and the display element, the processor adapted to execute program code stored in the memory to—
transmit information indicative of a current location of the device,
receive an alert from a central alert repository having an associated geographical boundary that coincides with the current location, the alert received over an open communication channel reserved for communication of alerts from the central alert repository, and
present content of the alert to a user of the device.

17. The device of claim 16, wherein the program code to cause the processor to present content of the alert to a user of the device comprises program code to cause the processor to display the content on the display element.

18. The device of claim 16, wherein the content comprises audio content and wherein the program code to cause the processor to present content of the alert to a user of the device comprises program code to render the audio content on the device.

19. The device of claim 16, wherein the program code to cause the processor to receive an alert from a central alert repository comprises program code to receive a priority level associated with the alert.

20. The device of clam 19, wherein the program code to cause the processor to present content of the alert to a user of the device comprises program code to cause the processor to present the content based, at least in part, on the priority level.
